(19) United States
(12) Patent Application Publication
(10) Pub. No.: US 2011/0205851 A1
(43) Pub. Date: Aug. 25, 2011

(54) E-Watch

(76) Inventor: Jared Harris, Texas City, TX (US)

(21) Appl. No.: 13/023,588

(22) Filed: Feb. 9, 2011

Related U.S. Application Data
(60) Provisional application No. 61/307,064, filed on Feb. 23, 2010.

(51) Int. Cl. G04B 47/06; G04B 47/00

(52) U.S. Cl. 368/14; 368/10

(57) ABSTRACT

An architecture is presented that provides a smart watch device. The smart watch device comprises a fastening band for securing the smart watch to a user, a display face for displaying time, day, and date information, and a plurality of watch control means by which the user can adjust the time, day and date information. Further, the smart watch device comprises control circuitry; an electronic memory component; microphone and speaker units for audio input and output, including a coder/decoder for conversions between analog and digital data forms; and a user input interface including a keypad for dialing and function selection, that allow a user to send and receive messages, such as email messages, text messages, audio messages and/or digital images and/or perform other functions. Additionally, various icons are located on the display face to enable users to send and receive messages and/or perform other functions with ease.

### CROSS-REFERENCE

This application claims priority from Provisional Patent Application Ser. No. 61/307,064 filed Feb. 23, 2010.

### BACKGROUND

A significant number of calls, emails and text messages are missed or receipt delayed because a user has his or her cell phone or smart phone tucked away in a pocket or in a purse. Cellular and smart phones can be bulky to carry and it is not always possible to have them readily available. It would be convenient to have a device to receive and send messages and phone calls that is discreet, able to be secured to a user and easily accessible at all times.

Consequently, a need exists for a smart watch that provides capabilities similar to that of a smart phone. The E-Watch device provides users with, among other features, a digital smart watch equipped with Internet capability, GPS technology and a silent alarm for emergencies. Men and women of virtually any age can use it to exchange digital images and messages with other E-Watch users, and with other cellular and smart phone users, as well as to an associated website. Everyone could benefit from the E-Watch device, whether to use it to ensure they do not miss an important business call, to check in with friends, or to browse the Internet.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a smart watch device. The smart watch device comprises a fastening band for securing the smart watch to a user, a display face for displaying time, day, and date information, and a plurality of watch control means by which the user can adjust the time, day and date information.

Furthermore in the preferred embodiment of the present invention, the smart watch device comprises control circuitry configured for managing operations of a digital telephone; an electronic memory component connected to the control circuitry; microphone and speaker units connected to the control circuitry for audio input and output, including a coder/decoder (CODEC) for conversions between analog and digital data forms; and a user input interface connected to the control circuitry including a keypad for dialing and function selection, that allows a user to send and receive messages, such as email messages, text messages, audio messages and/or digital images and/or perform other functions. Additionally, various icons are located on the display face to enable users to send and receive messages and/or perform other functions with ease. Specifically, the display face can comprise a signal icon, a message icon, a contact icon, an action icon, a battery icon and/or an Internet connection icon.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a smart watch device in accordance with the disclosed architecture.

FIG. 2 illustrates a perspective view of a user using the smart watch device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Cellular and smart phones can be bulky to carry and it is not always possible to have them readily available. It would be convenient to have a device to receive and send messages and phone calls that is discreet, able to be secured to a user and easily accessible at all times. The E-Watch device provides users with, among other features, a digital smart watch equipped with Internet capability, GPS technology and a silent alarm for emergencies. Men and women of virtually any age can use it to exchange digital images and messages with other E-Watch users, and with other cellular and smart phone users, as well as to an associated website.

Accordingly, the disclosed E-Watch device allows a user to send and receive messages, such as email messages, text messages, audio messages and/or digital images and/or perform other functions currently confined to computers and smart phones. A fastening band secures the E-Watch device to a user, and a display face displays time, day, and date information, as well as various icons to enable users to send and receive the messages and/or perform the functions with ease.

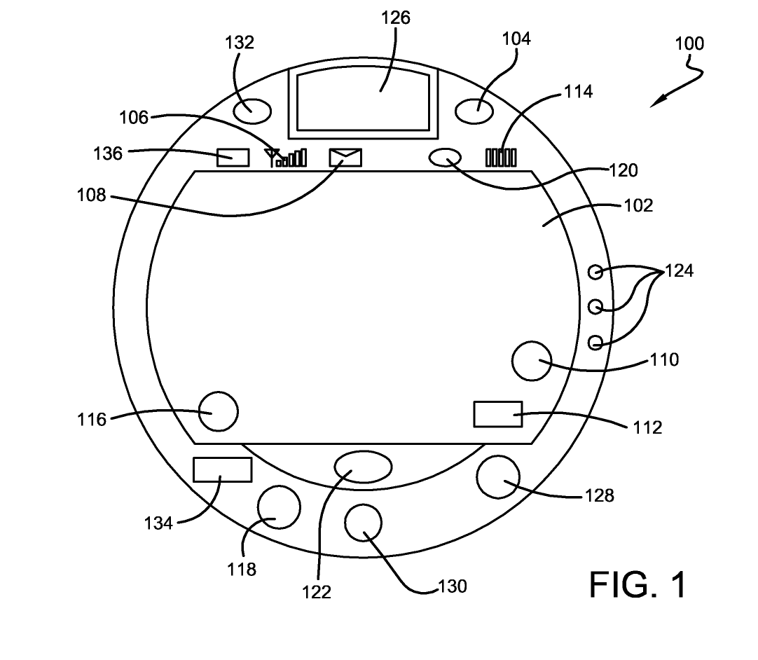

Referring initially to the drawings, FIG. 1 illustrates a smart watch device 100. The smart watch device 100 typically comprises a fastening band (not shown) for securing the smart watch to a user. The fastening band of the smart watch device 100 is secured to a user with any suitable closures, such as Velcro, a buckle, a clasp, etc. However, a fastening band is not required and the smart watch 100 can operate without a fastening band. The smart watch device 100 also comprises a display face 102 for displaying time, day, date and related information. A plurality of watch control means (not shown) by which the user can adjust the time, day, date and related information are also included on the display face 102, as well as a power button 104 for turning on and off the smart watch 100. In a preferred embodiment, the display face 102 comprises an LCD faceplate, however any suitable faceplate can be used without affecting the overall concept of the invention. The faceplate could also have a scratch-resistant coating to minimize wear and can be back-lit. The smart watch device 100 can also function as a stopwatch, if needed.

Additionally, the smart watch device 100 is provided comprising control circuitry configured for managing operations of a digital telephone; an electronic memory component 134 connected to the control circuitry; microphone 130 and speaker 128 units connected to the control circuitry for audio input and output, including a coder/decoder (CODEC) for conversions between analog and digital data forms; and a user input interface (not shown) connected to the control circuitry including a keypad for dialing and function selection. A telephone line port is provided in the control circuitry for connecting the digital telephone to a telephone line, and a serial communication port in the control circuitry provides communication with external digital equipment. There is in addition at least one Digital Signal Processor (DSP) microprocessor connected to the control circuitry for processing digitized audio signals. Further, the electronic memory component 134 comprises a memory card and a memory drive or Secure Digital (SD) card reader or a MultiMedia Card (MMC) card reader. Accordingly, the control circuitry in association with the electronic memory component 134, coder/decoder, DSP microprocessor and user input interface allows a user to not only send and receive, email messages, text messages, audio messages, and/or digital images, but also to check email, check social networking sites, manage daily schedules and complete other functions currently confined to computers and smart phones.

Furthermore, various icons are located on the display face 102 to enable users to send and receive messages, check email and social networking sites, manage schedules and complete other functions with ease. Specifically, the display face 102 comprises a signal icon 106, a message icon 108, a contact icon 110, an action icon 112, a battery icon 114 and/or an Internet connection icon 116. The signal icon 106 indicates reception in any given area. The smart watch device 100 can operate via a 3g network, satellite or Wi-Fi type of communication, depending on the locations and needs of a user. The message icon 108 indicates whether the user has an email or audio message waiting. The contact icon 110 indicates when another smart watch user is attempting to notify the user via watch-to-watch contact, or whether a cellular or smart phone user is attempting to notify the user or whether a landline user is attempting to notify the user. The smart watch device 100 is able to contact other smart watch users and cellular/smart phone users face-to-face and to communicate with them in real time. Further, the action icon 112 indicates a response has been posted on an interrelated website profile. The battery icon 114 notifies a user of the present battery charge of the smart watch. The smart watch device 100 preferably uses a rechargeable battery, but could also use any other suitable battery as is known in the art. The Internet connection icon 116 enables a user to connect to the Internet via the smart watch device 100.

Additionally, the smart watch device 100 can include other components, such as a GPS locator component 136 and/or an alarm button 118. The GPS locator component 136 allows users to keep track of the smart watch and prevents theft. It can also be used to keep track of the smart watch users themselves, so family members can keep track of one another for safety and security reasons. The silent alarm button or emergency/home-base button 118 is included for safety and security reasons as well, it could be pressed to notify emergency services, or to return a user to their “home” settings. The smart watch device 100 could also include a volume/mute button 120, a brightness button 122, and/or an option, menu and settings button 124. The volume/mute button 120 can be used to control the audio features. The brightness button 122 enables a user to control the brightness/contrast of the display face 102 of the smart watch device 100. The option, menu and settings button 124 enables users to customize features of the smart watch toward their own specific needs.

Furthermore, the smart watch device 100 can comprise a camera 126. The camera 126 is preferably between a 5.0-8.0 megapixel camera, though other resolutions can be employed without affecting the overall concept of the present invention. The camera 126 allows the smart watch device 100 to communicate face-to-face with other users in real time.

Additionally, the smart watch device 100 comprises a website/database component 132. The website/database component 132 allows the user to register their smart watch, create an online profile and choose and manage their personal smart watch plan. Once the smart watch 100 is registered, the website can connect and match the user to other users in a manner similar to that employed by social networking sites. Users can approve or ignore connection requests. The connection between users could be instant and in real time. The website can connect people to people, business to business, and businesses to customers.

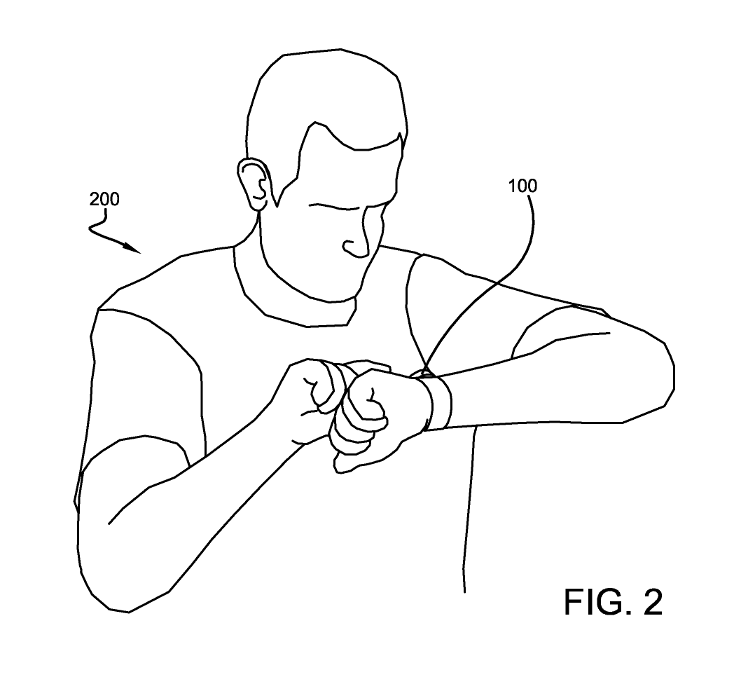

FIG. 2 illustrates the smart watch device 100 in use, wherein a user 200 is able to send and receive email messages, audio messages, and/or digital images, check email, check social networking sites, manage daily schedules and complete other functions.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart watch comprising:
a fastening band for securing the smart watch to a user;
a display face for displaying time, day, and date information;
a plurality of watch control means by which the user can adjust the time, day and date information; and
control circuitry; an electronic memory component; and a user input interface that allows the user to send and receive email messages, text messages, audio messages or digital images.

2. The digital smart watch of claim 1, wherein the display comprises an LCD faceplate.

3. The digital smart watch of claim 2, wherein the LCD faceplate comprises a signal icon, a message icon, a contact icon, an action icon, a battery icon, or an Internet connection icon.

4. The digital smart watch of claim 1, further comprising a GPS locator component.

5. The digital smart watch of claim 1, further comprising an alarm button.

6. The digital smart watch of claim 1, wherein the display further comprises a volume/mute button, a brightness button, or an option, menu and settings button.

7. The digital smart watch of claim 1, further comprising a camera.

8. The digital smart watch of claim 7, wherein the camera is between 5.0-8.0 megapixels.

9. The digital smart watch of claim 1, further comprising a speaker and a microphone.

10. The digital smart watch of claim 9, further comprising a website/database component.

11. The digital smart watch of claim 10, wherein the website/database component allows the user to register their smart watch, create an online profile and manage their plan.

12. A smart watch system, comprising:
a website/database component; and
a smart watch, wherein the smart watch comprises a fastening band, a display face, and a plurality of watch control means, and wherein the smart watch comprises control circuitry, an electronic memory component, and a user input interface that allows a user to send and receive a message.

13. The smart watch system of claim 12, wherein the electronic memory component comprises a memory card and a memory drive.

14. The smart watch system of claim 13, wherein the message comprises an email message, a text message, an audio message, or a digital image.

15. The smart watch system of claim 12, wherein the website/database component allows the user to register the smart watch system, create an online profile and manage a plan.

16. The smart watch system of claim 12, wherein the display face is an LCD faceplate comprising a signal icon, a message icon, a contact icon, an action icon, a battery icon or an Internet connection icon.

17. The smart watch system of claim 12, further comprising a GPS locator component.

18. A smart watch, comprising:
a fastening band for securing the smart watch to a user;
an LCD faceplate for displaying time, day, or date information;
a plurality of watch control means by which the user can adjust one or more of the time, day or date information; and
control circuitry, an electronic memory component, and a user input interface that allows the user to send and receive an email message, a text message, an audio message or a digital image;
wherein the LCD faceplate further comprises a signal icon, a message icon, a contact icon, an action icon, a battery icon or an Internet connection icon.

19. The smart watch of claim 18, wherein the electronic memory component comprises a memory card and a memory drive.

20. The smart watch of claim 19, further comprising a website/database component that allows the user to register their smart watch, create an online profile and manage their plan.
